(19) United States
(12) Patent Application Publication
(10) Pub. No.: US 2004/0163518 A1
(43) Pub. Date: Aug. 26, 2004

(54) Separator assembly for filler device and associated method

(76) Inventors: Michael Resterhouse, Muskegon, MI (US); Robert Reils, New Lenox, IL (US)

Correspondence Address: King & Jovanovic, PLC, 170 College Avenue, SUITE 230, HOLLAND, MI, 49423, US

(21) Appl. No.: 10/701,862

(22) Filed: Nov. 5, 2003

Related U.S. Application Data
(63) Continuation-in-part of application No. 10/268,551, filed on Oct. 10, 2002, now Pat. No. 6,725,633.
Application No. 10/268,551 is a continuation-in-part of application No. PCT/US01/13472, filed on Apr. 26, 2001.

(51) Int. Cl. B26D 7/02

(52) U.S. Cl. 83/451

(57) ABSTRACT

A separator assembly for separating a container from a web of at least two containers, comprising a frame member, a clamp, a clamp actuator, a blade assembly and a blade actuator. The frame includes a base. The clamp is associated with the frame member. The clamp includes a lower surface defined by at least two legs and a slot positioned therebetween to, in turn, facilitate the clamping of a portion of a web of at least two containers relative to the base. The clamp actuator is associated with each of the at least one clamp and the frame. The at least one clamp actuator is capable of selectively moving the at least two legs and the slot of the lower surface of the at least one clamp relative to the frame, to, in turn, releasably clamp a portion of a web of at least two containers between the base and the at least two legs. The blade assembly is associated with the base. The blade actuator is associated with the blade assembly, the blade actuator is capable of selectively moving the blade assembly transversely across the slot of the lower surface of the at least one clamp.

### CROSS-REFERENCE TO RELATED APPLICATION

This application is a continuation-in-part application of co-pending U.S. patent application Ser. No. 10/268,551 filed Oct. 10, 2002, entitled “Separator Assembly for Filler Device and Associated Method,” which is a continuation-in-part application of co-pending PCT Patent Application Serial Number PCT/US01/13472 filed Apr. 26, 2001, entitled “Separator Assembly for Filler Device and Associated Method”, which claims the priority of U.S. patent application Ser. No. 09/584,467 filed May 31, 2000, entitled “Separator Assembly for Filler Device and Associated Method.”

### BACKGROUND OF THE INVENTION

1. Field of the Invention

The present invention relates in general to a separator assembly, and more particularly, to a separator assembly, for use in association with a filler device, which is configured to separate associated containers prior to filling of the same.

2. Background Art

Separator assemblies for use in association with filler devices have been known in the art for years. To the best of Applicant's knowledge, many separator assemblies are configured to separate two or more containers after the containers have been at least partially filled, whereby the mass of the matter within the containers substantially assists in the separation process. While these separator assemblies are commercially acceptable for use in non-rotary filler devices, their use in rotary filler devices remains problematic inasmuch as many containers are provided in a web form, which can not be properly articulated through such a rotary filler device. In addition, separator assemblies are also configured to separate two or more containers after the containers have been at least partially filled. However, such assemblies comprise a notched blade for accommodating the rim of the containers, which hinders and/or precludes proper separation of associated containers near the notched region of the blade.

It is therefore an object of the present invention to provide a reliable separator assembly for use in association with rotary filler devices, which remedies the detriments and/or complications associated with conventional separator assemblies configured for use with non-rotary filler devices.

These and other objects of the present invention will become apparent in light of the present specification, claims, and drawings.

### SUMMARY OF THE INVENTION

The invention comprises a separator assembly for separating a container from a web of at least two containers. The separator assembly comprises a frame member, a clamp, a clamp actuator, a blade assembly and a blade actuator. The frame includes a base. The clamp is associated with the frame member. The clamp includes a lower surface defined by at least two legs and a slot positioned therebetween to, in turn, facilitate the clamping of a portion of a web of at least two containers relative to the base. The clamp actuator is associated with each of the at least one clamp and the frame. The at least one clamp actuator is capable of selectively moving the at least two legs and the slot of the lower surface of the at least one clamp relative to the frame, to, in turn, releasably clamp a portion of a web of at least two containers between the base and the at least two legs. The blade assembly is associated with the base. The blade actuator is associated with the blade assembly, the blade actuator is capable of selectively moving the blade assembly transversely across the slot of the lower surface of the at least one clamp, to, in turn, separate a container from a web of containers.

In a preferred embodiment, the blade assembly further comprises a blade having at least one concave blade surface. In another such preferred embodiment, the blade assembly further comprises a blade having at least two concave blade surfaces opposing each other, such that transverse movement in either a first direction or an opposing second direction results in the cutting of a web clamped by the at least one clamp. Preferably, the at least one concave blade surface comprises a semi-circular configuration.

In another preferred embodiment, the blade actuator further comprises an actuator motor, at least one guide pulley, and a belt member. The at least one guide pulley is spaced apart from the actuator motor. The belt member is configured to extend about each of the actuator motor and the at least one guide pulley, wherein the blade assembly is coupled to the belt member.

In a preferred embodiment, the base further comprises means for guiding the blade along the slot. In one such embodiment, the blade guiding means further comprises a guide rail disposed proximate the slot and a guide channel fixed with the blade assembly. The guide rail and the guide channel further comprise mating configurations, such that, upon mating engagement, slidable movement is permitted of the guide channel along the guide rail.

In another aspect of the invention, the invention is directed to a separator assembly for separating a container from a web of at least two containers. The assembly comprises a frame, a handle, at least one clamp, at least one clamp actuator, a blade assembly and a blade actuator. The frame member includes a base. The handle member includes a second end capable of pivotable and translative movement relative to the frame. The at least one clamp is associated with a first end of the handle member. The at least one clamp actuator is pivotally associated at a first end with the frame member and pivotally associated at a second end with the handle member between the first and second ends thereof. The at least one clamp actuator capable of selectively moving the at least one clamp relative to the base, to, in turn, releasably clamp a portion of a web of at least two containers therebetween. The blade assembly is associated with the base. The blade actuator is associated with the blade assembly. The blade actuator is capable of selectively moving the blade assembly transversely across the slot of the lower surface of the at least one clamp, to, in turn, separate a container from a web of containers.

### BRIEF DESCRIPTION OF THE DRAWINGS

The invention will now be described with reference to the drawings wherein:

FIG. 1 of the drawings is a perspective schematic representation of a separator assembly in accordance with the present invention;

FIG. 2 of the drawings is a cross-sectional schematic representation of a separator assembly in accordance with the present invention;

FIG. 3 of the drawings is a cross-sectional schematic representation of a separator assembly associated with a filler device;

FIG. 4 of the drawings is a perspective schematic representation of a separator assembly in accordance with the present invention;

FIG. 5 of the drawings is a front plan view of a blade of the present invention;

FIG. 6 of the drawings is a perspective schematic representation of a separator assembly in accordance with the present invention;

FIG. 7 of the drawings is a front plan view of a blade assembly of the present invention; and

FIGS. 8a-8f of the drawings is a front plan view of various blade assemblies of the present invention, showing, various concave blade configurations.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, are identified throughout the drawings by like reference characters.

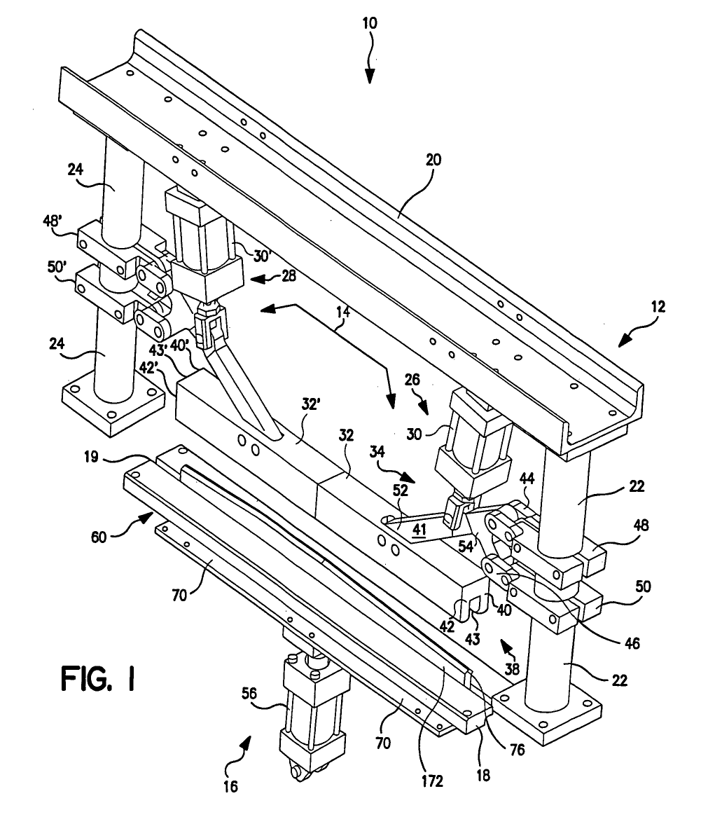

Referring now to the drawings and to FIG. 1 in particular, a perspective schematic representation of a first embodiment of separator assembly 10 is shown, which generally comprises frame 12, means 14 for clamping a container to frame 12, means 16 for separating the containers relative to each other. Specifically, as will be explained, separator assembly 10 is generally utilized to separate containers, such as bags and the like, which are attached to each other to form a web. For certain applications, it is advantageous to separate the containers prior to the filling of the containers. One such application is when the containers are associated with a rotary filler device.

It will be understood that the Figures are merely schematic representations. As such, some of the components have been distorted from their actual scale for pictorial clarity.

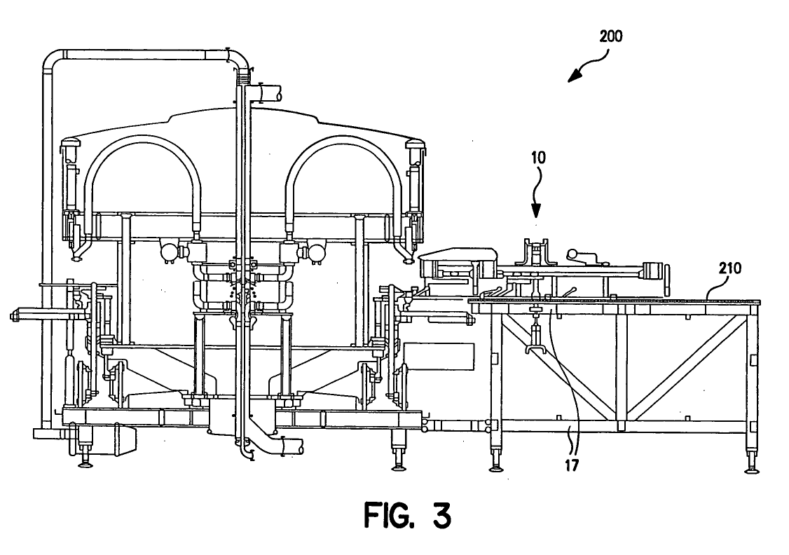

As is shown in FIG. 3, separator assembly 10 is primarily intended for use in association with filler device 200, which is capable of filling associated containers and/or bags with any one of a number of materials in solid, liquid, and/or gaseous states. It will be understood that while separator assembly 10 has been shown, for illustrative purposes only, as being associated with a rotary filler device, numerous other device configurations that would be known to those having ordinary skill in the art with the present disclosure before them are likewise contemplated for use.

Frame 12 is shown in FIG. 1 as comprising base 18, upper support 20 and posts 22 and 24. As will be understood, frame 12 is positioned on support member 17 (FIG. 3) which may rest on the ground (i.e. factory floor). Base 18 includes slot 19 extending therethrough for accepting blade 72 of separating means 16. Posts 22 and 24 extend substantially vertically away from the substantially horizontal base 18. Upper support 20 connects the upper ends of posts 22, 24 to each other. Frame 12 generally comprises a stainless steel material for durability purposes. However, the frame is not limited to any particular material, and, in fact, many materials are acceptable for use.

Posts 22 and 24 are substantially cylindrical in shape and are of sufficient length so as to permit the mounting of the clamping means 14 and enable the operation thereof. As will be explained below, the cylindrical shape facilitates adjustment of the operation of the clamping means. Additionally, posts 22 and 24 are spaced apart a distance which is greater that the width of the containers that may be passed through separator assembly 10.

Clamping means 14 is shown in FIG. 1 as comprising first assembly 26 and second assembly 28. Each assembly is substantially identical, and, therefore, the first assembly will be described with the understanding that the second assembly is substantially identical thereto. Specifically, first assembly 26 includes actuator 30, clamp 32 and means 34 for attaching the actuator to the clamp. Actuator 30 comprises an air cylinder which is pivotally attached to each of attachment means 34 and upper support 20. Of course, other actuators, such as hydraulic actuators or electric solenoids and the like are also contemplated for use.

Clamp 32 comprises a “C” channel 38 having legs 40, 42, and slot 43. The “C” channel is of a length which is approximately half of the width of the container or greater. As will be explained, legs 40, 42 cooperate with base 18 to clamp two containers against the base, wherein a perforated separation seam becomes positioned within the slot. Clamp 32 may comprise various materials, such as natural and synthetic composites, metals including stainless steel and the like. However, the clamp is not limited to any particular material. In addition, other cross-sectional configurations are contemplated (i.e. other than a “C” channel), wherein a resulting slot is disposed about the lower surface thereof.

Attachment means 34 includes handle 41, first linkage 44, second linkage 46 and mounting structures 48, 50. Handle 41 includes first end 52 and second end 54. First end 52 is attached to clamp 32. Actuator 30 is attached to handle 41 between first end 52 and second end 54. First linkage 44 attaches second end 54 to mounting structure 48. Second linkage 46 attaches second end 54 to mounting structure 50. Mounting structures 48 and 50 are slidably positionable and attachable to post 22 of frame 12. Adjustments to the movement of clamp 32 can be made by slidably moving mounting structures 48 and 50 along post 22.

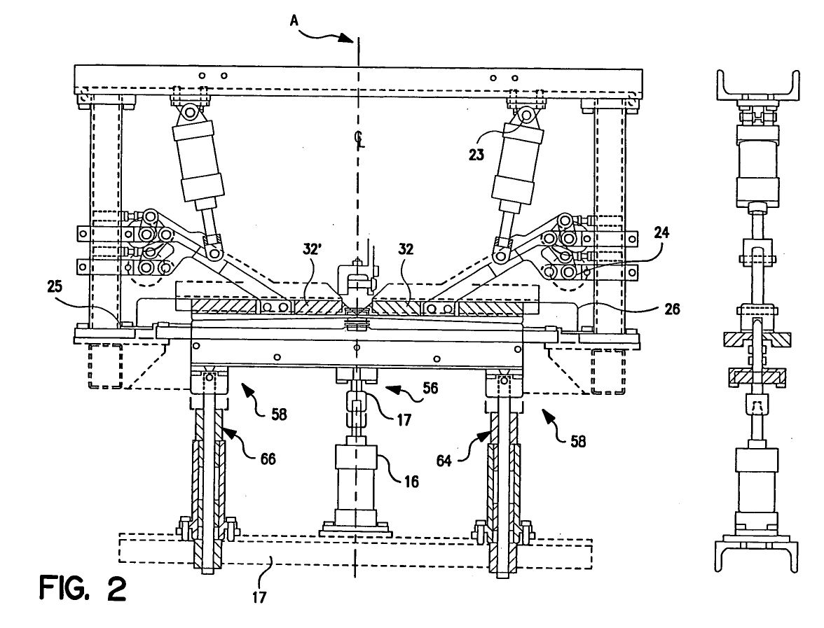

Separating means 16 is shown in FIG. 1 as comprising blade assembly 60, actuator 56 and means 58 for guiding the actuator (See FIG. 2). Blade assembly 60 includes blade holder 70 and blade 72. Blade 72 includes a peak 76 about the central region thereof. Blade 72 may comprise metals, as well as plastics, composites, and the like. Blade 72 is releasably fastened to blade holder 70 so that it may be removed for resharpening, or so that it may be replaced with a fresh blade.

Actuator 56 comprises an air cylinder which is capable of moving blade assembly 60 along the guiding means so that blade 72 can extend through slot 19 of base 18. Specifically, actuator 56 is attached to blade holder 70 at one end and to support member 17 at the other end (See FIG. 2). Various other actuators are contemplated for use, including various hydraulic and electric units.

As is shown in FIG. 2, guiding means 58 comprises two guide pins assemblies 64, 66 mounted on either side of blade 60 assembly. The guide pin assemblies are mounted on support member 17 and extend substantially vertically. The guide pin assemblies are slidably movable and are attached to blade holder 70. As will be explained in detail below, the guide means in sure that blade assembly 60 will be guided vertically upon actuation of actuator 56.

In operation, as shown in FIG. 3, a web of joined containers is advanced along surface 210 so that a perforation between any two containers becomes disposed about slot 19 of base 18 (See FIG. 1). At such time, clamping means 14 is actuated by actuating actuator 30 so as to move clamp 32 in contact with base 18. Specifically, actuation of actuator 30 will rotate and translate handle 41 about first and second linkages 44, 46 so that clamp 32 is directed toward base 18. As clamp 32 contacts base 18, legs 40, 42 straddle the perforation between the two containers positioned within slot 43. Similarly, actuator 30′ is actuated and, in turn, legs 40′, 42′ straddle the perforation to position the perforation within slot 43′.

Once clamps 32 and 32′ are fully actuated, as shown in FIG. 2, actuating means 56 of separating means 16 is activated. At such time, blade 72 begins to move upward under the direction of the actuating means and by the control of guiding means 58. At some point, peak 76 breaks the plane of base 18 and contacts the perforation of the containers. Inasmuch as the containers are clamped by legs 40 and 42, further movement of blade 72 pierces the perforation and, in turn, separates the containers.

Once the containers are separated, the actuating means 56 are de-energized and blade 72 retracts through slot 19 of base 18. Next, actuators 30, 30′ are de-energized and clamps 32, 32′ move away from base 18 and release two separated containers. Once separated and released, the released container is transmitted to a fill device, such as rotary filler device 200 (See FIG. 3). The web of containers is advanced, and the process is repeated to separate the next container. The process can be repeated until the entire web is separated.

It may from time to time become necessary to adjust the actuation of clamping means 14. To achieve same, mounting structures 48 and 50 (as well as 48′ and 50′) can be slidably moved along posts 22 and 24, respectively, and re-tightened as necessary. Likewise, it may become necessary to adjust the travel of guide means 58 to limit the travel of blade 72.

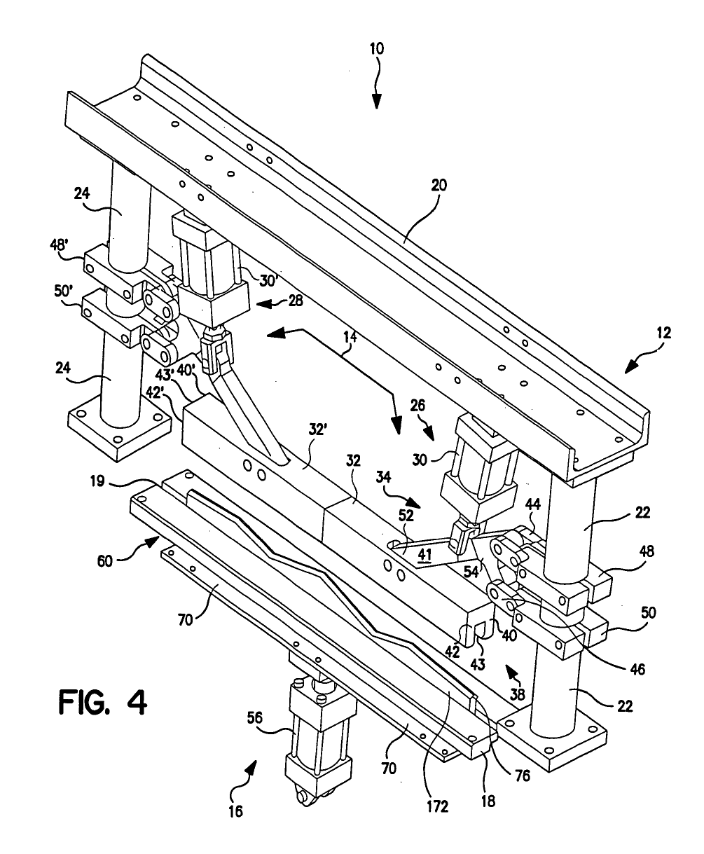

Referring now to FIG. 4, an alternative embodiment of the blade is shown generally at 172. Blade 172 is configured to facilitate the quick initiation of the separation of a container from of a web of containers, especially in regions wherein web retention and securement is minimized, while minimizing the vertical travel necessary by blade 172 to fully separate the container from the web of containers. Moreover, such a blade facilitates improved operation, especially in the instance wherein the clamps 32, 32′ are adjusted such that a small gap may develop therebetween.

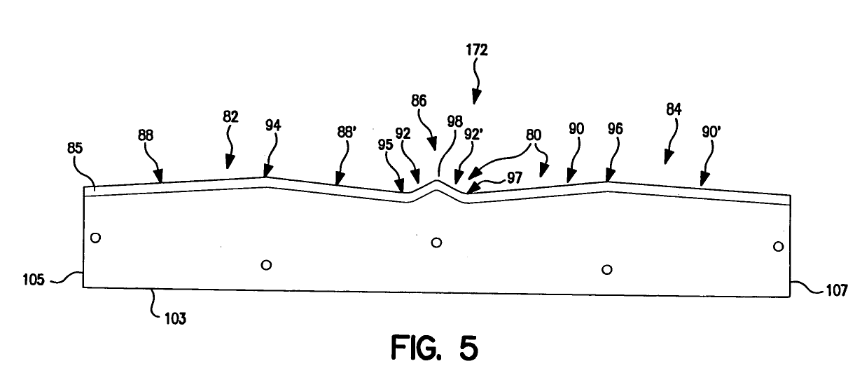

Blade 172 is shown in more detail in FIG. 5 as including a bottom surface 103, side edges 105, 107 and plurality of cutting sub-regions, such as sub-regions 80. As will be explained, the different sub-regions may be configured differently, so as to achieve different piercing and separating characteristics. In the particular embodiment shown, blade 172 includes a three cutting sub-regions, namely, side sub-regions 82, 84 and central sub-region 86. Of course, it will be understood that in varying embodiments, the sub-regions may each be configured differently, and, each of the sub-regions may be symmetrically or asymmetrically disposed along blade 172. Additionally, while three cutting sub-regions are shown in the present embodiment, it will be understood that embodiments having a greater or fewer number of cutting sub-regions are contemplated.

Sub-region 82 includes inclines 88, 88′ which are directed toward each other and which meet at peak 94 (i.e., substantially the highest point of the sub-region). Similarly, sub-region 84 includes inclines 90, 90′ which are also directed toward each other and which meet at peak 96. Central sub-region 86 includes inclines 92, 92′ which are directed toward each other and which meet at peak 98. As shown in FIG. 4, incline 88′ and incline 92 meet at valley 95 and incline 90 and 92′ meet at valley 97. In the embodiment shown, peak 98 extends above peaks 94, 96, such that, in use, peak 94 makes initial contact with the web of joined containers. It will be understood that the varying peaks may include surface configurations, such as serrations, or the like to further facilitate the cutting of the web of containers.

It will be understood that in various embodiments, a sub-region may include in excess of a single peak, and, in turn, may include a plurality of peaks which are connected by way of a pair of inclines or a substantially horizontal surface. In other embodiments, it will be understood that a sub-region may include only a single inclined surface and a peak (i.e., an incline which has its peak proximate the edge of blade).

Additionally, the absolute value of the slope of each of the inclines 92, 92′ of the central sub-region are generally greater than the absolute value of the slope of the inclines 88, 88′, 90, 90′ of the side sub-regions 82, 84. Similarly, inclines 88, 88′, 90, 90′ are longer than inclines 92, 92′. Of course, the slopes and the relative lengths of the various inclines can be varied by one of skill in the art.

The inclines 88, 88′, 90, 90′, 92, 92′ are positioned end to end, to form an integral and substantially continuous edge 83. The continuous edge may be sharpened to a fine edge to facilitate the separating of joined containers of the web. Of course, in certain embodiments, the separate sub-regions may comprise separate components which are attached together to form blade 172. As such, edge 83 may be discontinuous and may include separations in the blade. Such an embodiment may be useful, for example, wherein certain portions of edge 83 wear at faster rates than other portions of edge 83.

Referring again to FIG. 4, blade 172 is shown as being positioned within separator assembly 10. In operation of such an embodiment, as the web of joined containers is advanced along surface 210 (FIG. 3), the perforations between any two containers becomes disposed about slot 19 of base 18. Once clamped, the blade moves upward under the direction of the actuating means and by the control of the guiding means. Due to the configuration of blade 172, peak 98 of central sub-region 86 first contacts the web. Due to the relatively steep angle of inclines 92, 92′ thereof, peak 98 controllably, yet forcefully pierces the web, to facilitate the initial separation thereof. Inasmuch as legs 40 and 42 do not clamp the central region of the web, the steep angle facilitates the initiation of the separation of the web, without adversely and/or detrimentally pushing the web upwardly away from base 18.

Upon continued movement of the blade in an upward direction, peaks 94 and 96 of the side sub-regions 82, 84, respectively, contact and pierce the web. Finally, the inclines contact the web along the lengths thereof to fully separate the joined containers. The slope of the inclines surrounding peaks 94,96 may have a configuration which is not as steeply inclined as central peak 98.

It will be understood that as the absolute values of the inclines of the sub-regions increase, the vertical displacement of blade 172 required to achieve separation correspondingly increases. However, the greater the absolute value of the inclines of the sub-regions, the less force that is required to pierce the web, and the less displacement and/or stretching that is imparted upon the web prior to cutting. Advantageously, blade 172 facilitates the quick and controlled initial piercing of the web by way of central sub-region 86, while minimizing the vertical travel necessary by blade 172 to effectively separate the respective container of the web of attached containers.

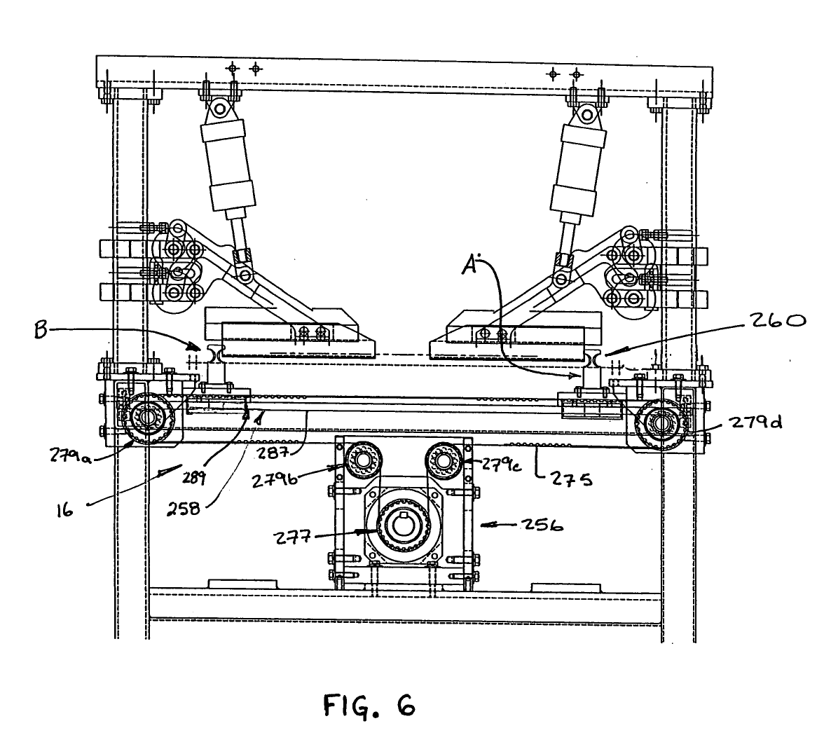

An alternative embodiment of separating means 16 is shown in FIG. 6. The separating means comprises blade assembly 260 (shown in each of position A and position B), blade actuator 256 and means 258 for guiding the blade assembly. Such a separating means may be utilized in place of the separating means disclosed in other embodiments of the present invention, to cut a bag from a web of bags.

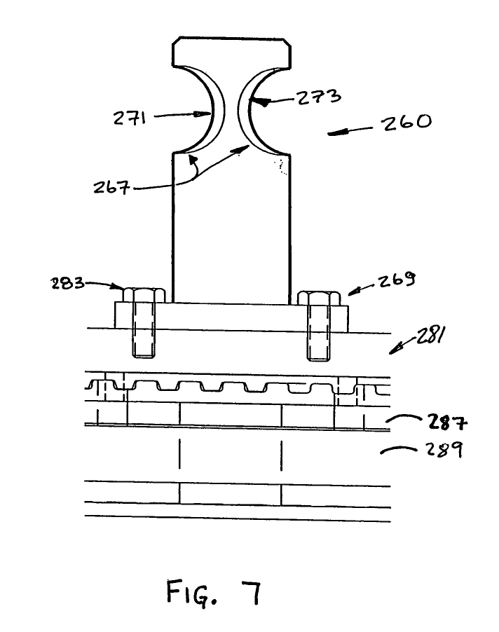

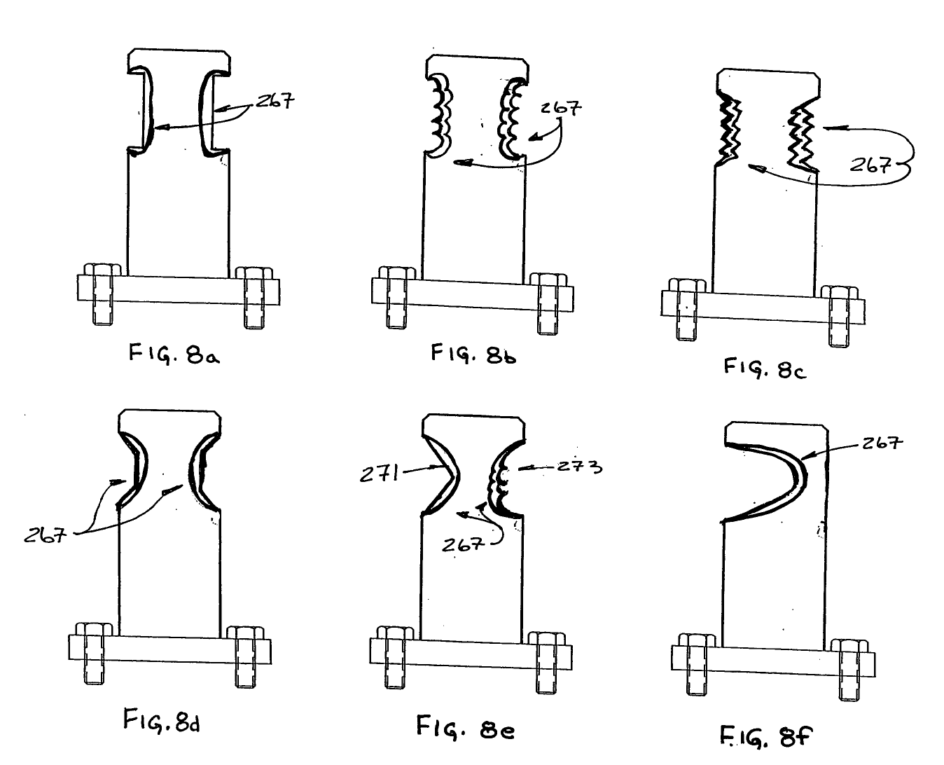

Specifically, blade assembly 260 is shown in detail in FIG. 7 as comprising blade 267 and blade attachment member 269. Blade 267 comprises outwardly concave blade surfaces 271 and 273. The concave blade surfaces 271, 273 in the embodiment shown comprise semi-circular, or arcuate configurations, and comprise substantially mirror images of each other. Advantageously, such a configuration provides an extended range of blade region with which to initiate a cut and to separate the web. Additionally, the concave configuration aids in the initiation of a cut, rather than the pushing of material out of the path of the blade without cutting same (i.e., the edge of the uncut web is captured and retained within the concave configuration). Other concave blade surfaces of blade 267 are shown in FIGS. 8a through 8f, with the understanding that these are merely exemplary, and other concave structures are likewise contemplated for use. It is likewise contemplated that outwardly concave surface 271 may have a configuration different that outwardly concave surface 273 (FIG. 8e). Of course, it is also contemplated that the blade may comprise a single outwardly concave blade surface (FIG. 8f).

Blade attachment member 269 is shown in FIG. 7 as comprising blade carrier 281 to which blade 267 is attached with a plurality of fasteners 283. Of course, various fasteners are contemplated for use, including, various hook and loop fasteners, bolts, screws, nuts, plates, adhesives, etc. Indeed, the invention is not limited to any particular type of blade attachment member. Additionally, other attachment assemblies are contemplated.

Blade actuator assembly 256 is shown in FIG. 6 as comprising actuating motor 277, guide pulleys 279a-279d, and belt 275. Actuating motor 277 comprises a servo motor which includes an output shaft to which a drive gear or pulley is rotatably coupled. Guide pulleys 279a-279d are strategically positioned so that belt 275 may be guided by the guide pulleys about the drive gear or pulley attached to the output shaft of actuating motor 277 and so that the belt may extend along and below the blade guide. The blade attachment member is coupled to belt 275 so that rotation of the actuating motor directs the blade across (and below) the blade guide from one end (represented by the blade in position A of FIG. 6) to the other end (represented by the blade in position B of FIG. 6), and back. Belt 275 may comprise any number of materials, such as v-belts, serpentine belts, cogged belts, straight belts as well as chains and the like. The invention is not limited to any particular configuration for belt 275. Of course, the position of the various components of the blade actuator assembly can be varied, as well as, that path of the belt, to achieve desired movement of the blade.

Blade assembly guiding means 258 is shown in FIG. 6 as comprising guide rail 287 and guide channel 289. As explained above, the slot is associated with base 18, and extends along the path of travel of the blade. As such, the slot provides a passage along which the blade may travel. Moreover, the slot provides protection for the various actuator components.

Guide rail 287 is coupled with the base and extends from one end of the slot to the other end of the slot. In the embodiment shown, the guide rail comprises a member of substantially uniform cross-sectional configuration. Guide channel 289 is associated with blade carrier 281. In particular, the guide channel extends along the lower end of the blade carrier. The guide channel includes a cross-sectional configuration which substantially mates with the cross-sectional configuration of the guide rail. As such, the guide channel is freely capable of moving along guide rail from end to end. Bearings may be provided on the guide channel to minimize friction, and to enhance the movement of the channel relative to the guide rail.

With reference to FIG. 6, in operation of such a configuration, blade assembly 260 initially is positioned in, for example position A, and, at least partially, positioned within the slot. At the appropriate time (under the direction of an analog or digitally based control system, not shown), actuating motor 277 initiates rotatable movement and begins to drive belt 275. Inasmuch as the blade assembly is coupled to belt 275, the blade assembly is directed toward the opposite position from which the blade movement was initiated (i.e., position B). In particular, the actuator directs movement of the blade and blade carrier, and the mating configuration of the guide rail 287 and guide channel 289 direct the blade and blade carrier in the proper direction along the slot.

As the blade is directed across the slot by the cooperation of guide rail 287 and guide channel 289, concave blade surface 271 contacts the web that spans across the slot and that is clamped to the surfaces opposing the blade guide on either side. Specifically, concave blade surface 271 cuts the web as the blade proceeds thereacross. When the blade reaches the opposing position (i.e., position B), or when the web has been completely separated, the actuator ceases movement. As the actuator ceases movement, the belt ceases movement thereby stopping the movement of the blade assembly.

Next, the web is advanced a predetermined distance, wherein it becomes desirable to again cut the web at a predetermined point. When directed, actuating motor 279 is actuated in a reverse direction, directing the blade along the slot, again directed by the cooperation between guide rail 287 and guide channel 289, toward the initial position (i.e., position A). Blade surface 273 contacts the web and initiates cutting of the web spanning across the slot. As the blade assembly cuts the web along the slot the blade assembly eventually reaches the opposite position, or the end of the web. At such time, the actuator, and in turn, the blade assembly ceases movement. Interestingly, the blade has now returned to its initial starting point, and is ready to repeat the cycle. Thus, for one complete cycle of the blade assembly, the web can be cut twice. Advantageously, there is very little lost motion with the separator assembly, and virtually any motion of the blade assembly results in the cutting of the web.

In other embodiments, particularly embodiments that operate at a slower pace, or where the blade includes a single concave blade surface (FIG. 8f), the blade may undertake the first pass to sever the web, and then may make a return pass before advancing the web in preparation of undertaking another severing operation.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A separator assembly for separating a container from a web of at least two containers, comprising:
a frame member having a base;
at least one clamp associated with the frame member, the at least one clamp including a lower surface defined by at least two legs and a slot positioned therebetween, wherein the two legs, and the slot are fixed to each other so as to be incapable of relative movement, to, in turn, facilitate the clamping of a portion of a web of at least two containers relative to the base;
at least one clamp actuator associated with each of the at least one clamp and the frame, the at least one clamp actuator capable of selectively moving the at least two legs and the slot of the lower surface of the at least one clamp relative to the frame, to, in turn, releasably clamp a portion of a web of at least two containers between the base and the at least two legs;
a blade assembly associated with the base; and
a blade actuator associated with the blade assembly, the blade actuator capable of selectively moving the blade assembly transversely across the slot of the lower surface of the at least one clamp.

2. The separator assembly of claim 1 wherein the blade assembly further comprises a blade having at least one concave blade surface.

3. The separator assembly of claim 2 wherein the blade assembly further comprises a blade having at least two concave blade surfaces opposing each other, such that transverse movement in either a first direction or an opposing second direction results in the cutting of a web clamped by the at least one clamp.

4. The separator assembly of claim 2 wherein the at least one concave blade surface comprises a semi-circular configuration.

5. The separator assembly of claim 1 wherein the blade actuator further comprises:
an actuator motor;
at least one guide pulley spaced apart from the actuator motor; and
a belt member configured to extend about each of the actuator motor and the at least one guide pulley, wherein the blade assembly is coupled to the belt member.

6. The separator assembly of claim 1 wherein the base further comprises means for guiding the blade along the slot.

7. The separator assembly of claim 6 wherein the blade guiding means further comprises a guide rail disposed proximate the slot and a guide channel fixed with the blade assembly, the guide rail and the guide channel further comprising mating configurations, whereupon engagement of same, the guide channel is slidably movable along the guide rail.

8. A separator assembly for separating a container from a web of at least two containers, comprising:
a frame member having a base;
a handle member having a second end capable of pivotable and translative movement relative to the frame;
at least one clamp being associated with a first end of the handle member; and
at least one clamp actuator pivotally associated at a first end with the frame member and pivotally associated at a second end with the handle member between the first and second ends thereof, the at least one clamp actuator capable of selectively moving the at least one clamp relative to the base, to, in turn, releasably clamp a portion of a web of at least two containers therebetween;
a blade assembly associated with the base; and
a blade actuator associated with the blade assembly, the blade actuator capable of selectively moving the blade assembly transversely across the slot of the lower surface of the at least one clamp.

9. The separator assembly of claim 8 wherein the blade assembly further comprises a blade having at least one concave blade surface.

10. The separator assembly of claim 9 wherein the blade assembly further comprises a blade having at least two concave blade surfaces opposing each other, such that transverse movement in either a first direction or an opposing second direction results in the cutting of a web clamped by the at least one clamp.

11. The separator assembly of claim 9 wherein the at least one concave blade surface comprises a semi-circular configuration.

12. The separator assembly of claim 8 wherein the blade actuator further comprises:
an actuator motor;
at least one guide pulley spaced apart from the actuator motor; and
a belt member configured to extend about each of the actuator motor and the at least one guide pulley, wherein the blade assembly is coupled to the belt member.

13. The separator assembly of claim 8 wherein the base further comprises a blade guide configured to direct the blade across the slot.
